(19) United States
(12) Patent Application Publication
(10) Pub. No.: US 2022/0180521 A1
(43) Pub. Date: Jun. 9, 2022

(54) IMAGE PROCESSING METHOD AND APPARATUS, AND ELECTRONIC DEVICE, STORAGE MEDIUM AND COMPUTER PROGRAM

(71) Applicant: SHANGHAI SENSETIME INTELLIGENT TECHNOLOGY CO., LTD, Shanghai (CN)

(72) Inventors: Yu WU, Shanghai (CN); Jing Yuan, Shanghai (CN); Liang Zhao, Shanghai (CN)

(21) Appl. No.: 17/676,288

(22) Filed: Feb. 21, 2022

Related U.S. Application Data
(63) Continuation of application No. PCT/CN2020/100730, filed on Jul. 7, 2020.

(30) Foreign Application Priority Data
Sep. 12, 2019 (CN) 201910865717.5

(51) Int. Cl. G06T 7/11; G06T 7/70; G06V 10/26; G06V 10/25

(52) U.S. Cl. CPC G06T 7/11; G06T 7/70; G06V 10/26; G06T 2207/20081; G06T 2207/20221; G06T 2207/20084; G06V 10/25

(57) ABSTRACT

An image processing method includes: performing first segmentation processing on an image to be processed, and determining a segmentation region of a target in said image (S11); determining, according to the position of the center point of the segmentation region of the target, an image region where the target is located (S12); and performing second segmentation processing on the image region where each target is located, and determining the segmentation result of the target in said image (S13).

### CROSS-REFERENCE TO RELATED APPLICATIONS

This application is a continuation of International Application No. PCT/CN2020/100730, filed on Jul. 7, 2020, which claims benefit of priority to Chinese Patent Application 201910865717.5, filed on Sep. 12, 2019. The disclosures of International Application No. PCT/CN2020/100730 and Chinese Patent Application 201910865717.5 are hereby incorporated by reference in their entireties.

### BACKGROUND

In the technical field of image processing, the segmentation on a Region of Interest (ROI) or an object region is the basis for image analysis and object identification. For example, with segmentation on a medical image, the boundary of one or more organs or tissues is identified clearly. The accurate segmentation of the medical image is of great importance to many clinical applications.

### SUMMARY

The embodiments of the disclosure relate to the technical field of computers, and relate, but not limited, to an image processing method and apparatus, an electronic device, a computer storage medium and a computer program.

The embodiments of the disclosure provide an image processing method and apparatus, an electronic device, a computer storage medium and a computer program.

The embodiments of the disclosure provide an image processing method, which may include: a first segmentation processing is performed on a to-be-processed image to determine segmentation regions of objects in the to-be-processed image; image regions where the objects are located are determined according to central point positions of the segmentation regions of the objects; and a second segmentation processing is performed on the image regions where the objects are located to determine segmentation results of the objects in the to-be-processed image.

The embodiments of the disclosure further provide and apparatus, including a memory storing processor-executable instructions, and a processor. The processor is configured to execute the stored processor-executable instructions to perform operations of: performing a first segmentation processing on a to-be-processed image to determine segmentation regions of objects in the to-be-processed image; determining, according to central point positions of the segmentation regions of the objects, image regions where the objects are located; and performing a second segmentation processing on the image regions where the objects are located to determine segmentation results of the objects in the to-be-processed image.

The embodiments of the disclosure further provide a non-transitory computer-readable storage medium having stored thereon computer-readable instructions that, when executed by a processor, cause the processor to perform a method, including: performing a first segmentation processing on a to-be-processed image to determine segmentation regions of objects in the to-be-processed image; determining, according to central point positions of the segmentation regions of the objects, image regions where the objects are located; and performing a second segmentation processing on the image regions where the objects are located to determine segmentation results of the objects in the to-be-processed image.

It is to be understood that the above general descriptions and detailed descriptions below are only exemplary and explanatory and not intended to limit the embodiments of the disclosure.

According to the following detailed descriptions on the exemplary embodiments with reference to the accompanying drawings, other characteristics and aspects of the embodiments of the disclosure become apparent.

### BRIEF DESCRIPTION OF THE DRAWINGS

The accompanying drawings, which are incorporated in and constitute a part of this specification, illustrate embodiments consistent with the disclosure and, together with the description, serve to explain the technical solutions in the embodiments of the disclosure.

FIG. 1 is a flowchart of an image processing method provided by an embodiment of the disclosure.

FIG. 2 is a schematic diagram of an application scenario provided by an embodiment of the disclosure.

FIG. 3A is a schematic diagram of core segmentation of an image processing method provided by an embodiment of the disclosure.

FIG. 3B is another schematic diagram of core segmentation of an image processing method provided by an embodiment of the disclosure.

FIG. 4A is a schematic diagram of core segmentation with missed segmentation in an image processing method provided by an embodiment of the disclosure.

FIG. 4B is a schematic diagram of core segmentation with excessive segmentation in an image processing method provided by an embodiment of the disclosure.

FIG. 5 is a schematic diagram of a central point of an object segmentation region in an image processing method provided by an embodiment of the disclosure.

FIG. 6A is a schematic diagram of a segmentation region with wrong segmentation in an image processing method provided by an embodiment of the disclosure.

FIG. 6B is a schematic diagram of a segmentation region after correction of a wrong segmentation situation shown in FIG. 6A in an embodiment of the disclosure.

FIG. 7A is a schematic diagram of another segmentation region with wrong segmentation in an image processing method provided by an embodiment of the disclosure.

FIG. 7B is a schematic diagram of a segmentation region after correction of a wrong segmentation situation shown in FIG. 7A in an embodiment of the disclosure.

FIG. 8 is a schematic diagram of a processing process of an image processing method provided by an embodiment of the disclosure.

FIG. 9 is a structure diagram of an image processing apparatus provided by an embodiment of the disclosure.

FIG. 10 is a structure diagram of an electronic device provided by an embodiment of the disclosure.

FIG. 11 is a structure diagram of another electronic device provided by an embodiment of the disclosure.

### DETAILED DESCRIPTION

Localization and segmentation on the vertebra are the key steps for diagnosis and treatment of vertebral diseases such as vertebral slip, degeneration of intervertebral disc/vertebra, and spinal stenosis. The vertebra segmentation is also the pretreatment step for diagnosis of scoliosis, osteoporosis and other spinal lesions. Most computer-aided diagnosis systems are based on manual segmentation performed by doctors, which has the defects of long time consumption and irreproducible result. Hence, constructing systems for diagnosis and treatment of the spine with the computer requires automatic positioning of vertebral structures, detection and segmentation.

In the related art, how to accurately segment the medical image such as a human vertebral image is a technical problem to be solved urgently. For the above-mentioned problem, the technical solutions of the embodiments of the disclosure are provided.

Various exemplary embodiments, features and aspects of the disclosure will be described below in detail with reference to the accompanying drawings. The same reference signs in the drawings represent components with the same or similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the embodiments of the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

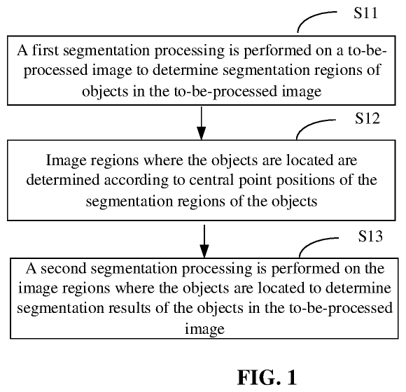

FIG. 1 is a flowchart of an image processing method provided by an embodiment of the disclosure. As shown in FIG. 1, the image processing method includes the following steps.

S11, performing a first segmentation processing on a to-be-processed image to determine segmentation regions of objects in the to-be-processed image.

S12, determining, according to central point positions of the segmentation regions of the objects, image regions where the objects are located.

S13, performing a second segmentation processing on the image regions where the objects are located to determine segmentation results of the objects in the to-be-processed image.

In some embodiments of the disclosure, the image processing method is executed by an image processing apparatus. The image processing apparatus is User Equipment (UE), a mobile device, a user terminal, a terminal, a cell phone, a cordless phone, a Personal Digital Assistant (PDA), a handheld device, a computing device, a vehicle device, a wearable device and the like. The method is implemented in a manner that the processor calls the computer-readable instructions stored in the memory. Or, the method is executed by a server.

In some embodiments of the disclosure, the to-be-processed image is 3D image data, such as a 3D vertebral image. The 3D vertebral image includes multiple slice images in a cross-sectional direction of the vertebra. Classes of the vertebra includes a cervical vertebra, a spine, a lumbar vertebra, a caudal vertebra, a thoracic vertebra, etc. The to-be-processed image is obtained by scanning the body of the tested object (such as the patient) with an image collection device like a Computed Tomography (CT) device. It is to be understood that the to-be-processed image is also an image of another region or another type. There are no limits made on the region, type and specific acquisition manner of the to-be-processed image in the disclosure.

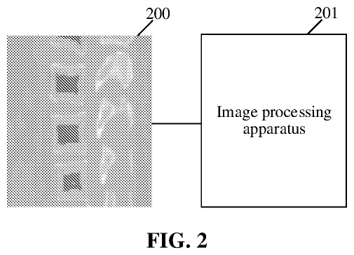

The image processing method in some embodiment of the disclosure is applied to auxiliary diagnosis, vertebral 3D printing and other application scenarios of vertebral diseases. FIG. 2 is a schematic diagram of an application scenario provided by an embodiment of the disclosure. As shown in FIG. 2, the CT image 200 of the spine is the to-be-processed image. The to-be-processed image is input to the image processing apparatus 201, and the segmentation result of each vertebra in the CT image of the spine is obtained by processing with the image processing method in the foregoing embodiment. For example, when the target is a single vertebra, the segmentation result of the single vertebra is obtained, and then the shape and condition of the single vertebra is determined. The segmentation on the CT image of the spine is also helpful for early diagnosis, surgical planning and positioning of spinal lesions, such as degenerative diseases, deformations, injuries, tumors and fractures. It is to be noted that the scenario shown in FIG. 2 is only an illustrative scenario in the embodiment of the disclosure, and there are no limits made on the specific application scenarios in the disclosure.

In some embodiments of the disclosure, the to-be-processed image is segmented in order to locate objects (such as the spine) in the to-be-processed image. Prior to segmentation, the to-be-processed image is preprocessed to unify the value ranges of the spacing resolution ratio and the pixel value of the to-be-processed image, etc.; in this way, the size of the image is unified, and the amount of data to be processed is reduced. There are no limits made on the specific content and processing manner in preprocessing. For example, the preprocessing method is to rescale the range of the pixel values in the to-be-processed image, perform a central crop on the image, and the like.

In some embodiments of the disclosure, the first segmentation is performed on the preprocessed to-be-processed image in step S11. For each slice image in the to-be-processed image, the slice image and N slice images (N being a positive integer) upwardly and downwardly adjacent to the slice image, i.e., 2N+1 slice images, are taken. The 2N+1 slice images are input to corresponding segmentation networks for processing, such that segmentation regions of the slice images are obtained. In this way, by processing the slice images in the to-be-processed image respectively, segmentation regions of multiple slice images are obtained, and thus the segmentation regions of the objects in the to-be-processed image are determined. Each segmentation network includes a convolutional neutral network, and there are no limits made on the structure of the segmentation network in the disclosure.

In some embodiments of the disclosure, by segmenting different classes of objects through corresponding segmentation networks, i.e., respectively inputting the preprocessed to-be-processed image to segmentation networks corresponding to the different classes of objects for segmentation, segmentation regions for the different classes of objects are obtained.

In some embodiments of the disclosure, the objects in the to-be-processed image include a first object belonging to a first class and/or a second object belonging to a second class. The first class includes at least one of a cervical vertebra, a spine, a lumbar vertebra or a thoracic vertebra; and the second class includes a caudal vertebra. For the first object such as the cervical vertebra, the spine, the lumbar vertebra or the thoracic vertebra, the first segmentation processing is a core segmentation, such that a core segmentation region of each vertebra is obtained after the segmentation, thereby localizing each vertebra. For the second object (such as the caudal vertebra), as the features are greatly different from those of other objects, instance segmentation is directly performed to obtain the segmentation region. In the embodiment of the disclosure, the core segmentation may be a segmentation process for segmenting a core region.

In some embodiments of the disclosure, the first class of object is re-segmented after the core segmentation region is determined. In step S12, according to positions of the central point in core segmentation region of the object, the image regions where the objects are located are determined, i.e., bounding boxes of the objects and ROIs defined by the bounding boxes are determined, so as to facilitate further segmentation. For example, cross sections where two central points upwardly and downwardly adjacent to the central point of the segmentation region of the present object are located respectively are used as boundaries to define the bounding box of the present object. There are no limits made on the specific determination manner of the image region in the disclosure.

In some embodiments of the disclosure, the second segmentation processing is performed on the image region where each object is located to obtain the segmentation result of each first object in step 13. The second segmentation processing is, for example, instance segmentation. After processing, the instance segmentation result of each object in the to-be-processed image, i.e., the instance segmentation region of each object of the first class, is obtained.

In the embodiment of the disclosure, the core regions of the objects are determined through the first segmentation to localize the objects; the ROI of each object is determined according to the central point of each core region; and the second segmentation processing is performed on the ROIs to determine the instance segmentation result of each object, thereby implementing the instance segmentation on the objects. Therefore, the accuracy and robustness of segmentation are improved.

In some embodiments, step S11 includes the following operations:

Performing the resampling and pixel value reduction on the to-be-processed image to obtain a processed first image.

Performing the central cropping on the first image to obtain a cropped second image.

Performing the first segmentation processing on the second image to determine the segmentation regions of the objects in the to-be-processed image.

For example, prior to the segmentation of the to-be-processed image, the to-be-processed image is preprocessed. The resampling is performed on the to-be-processed image to unify the spacing resolution ratio of the to-be-processed image. For example, for the segmentation of the spine, the spacing resolution ratio of the to-be-processed image is adjusted to 0.8*0.8*1.25 mm³. For the segmentation of the caudal vertebra, the spacing resolution ratio of the to-be-processed image is adjusted to 0.4*0.4*1.25 mm³. There are no limits made on the specific resampling manner and the spacing resolution ratio of the to-be-processed image after the resampling in the disclosure.

In some embodiments of the disclosure, the pixel value reduction is performed on the to-be-processed image after the resampling to obtain the processed first image. For example, the pixel value of the to-be-processed image after the resampling is intercepted to [−1024, inf], and then rescaled. For example, the rescale time is 1/1024. The inf represents that the upper limit of the pixel value is not intercepted. After the pixel value is reduced, the pixel value of the obtained first image is adjusted to [−1, inf]. In this way, the value range of the image is reduced to accelerate the convergence of the model.

In some embodiments of the disclosure, the central crop is performed on the first image to obtain the cropped second image. For example, for the segmentation of the spine, with the center of the first image as a reference position, each slice image of the first image is cropped into a 192*192 image, and the pixel value at the position insufficient to 192*192 is filled as −1; and for the segmentation of the caudal vertebra, with the center of the first image as a reference position, each slice image of the first image is cropped into a 512*512 image, and the pixel value at the position insufficient to 512*512 is filled as −1. It is to be understood that the cropping sizes for different classes of objects is set by a person skilled in the art according to an actual situation, and there are no limits made thereto in the disclosure.

In some embodiments of the disclosure, after preprocessing, the first segmentation processing is performed on the preprocessed second image to determine the segmentation regions of the objects in the to-be-processed image.

In this way, the size of the image is unified, and the amount of data to be processed is reduced.

In some embodiments of the disclosure, the segmentation regions of the objects in the to-be-processed image include a core segmentation region of a first object, the first object is an object belonging to a first class in the objects, and correspondingly, step S11 includes the following operation:

Performing a core segmentation processing on the to-be-processed image through a core segmentation network to determine a core segmentation region of the first object.

For example, for the first class of object such as the cervical vertebra, the spine, the lumbar vertebra or the thoracic vertebra (i.e., the first object), the first segmentation processing is a core segmentation, such that a core segmentation region of each vertebra is obtained after the segmentation, thereby localizing each vertebra. Wherein, the core segmentation network is preset so as to perform the core segmentation on the preprocessed to-be-processed image. The core segmentation network is, for example, a convolutional neural network, such as a UNet-based 2.5D segmentation network model, including a residual encoding network (e.g., Resnet34), an attention-based module, and a decoding network (Decoder). There are no limits made on the structure of the core segmentation network in the disclosure.

Thus, in the embodiment of the disclosure, the core segmentation processing is performed on the to-be-processed image to obtain the core segmentation regions of the objects, which is helpful to accurately determine the image regions where the objects are located on the basis of the segmentation regions of the objects.

In some embodiments of the disclosure, the to-be-processed image includes a 3D vertebral image. The 3D vertebral image includes multiple slice images in a cross-sectional direction of the vertebra.

The step that the core segmentation processing is performed on the to-be-processed image through the core segmentation network to determine the core segmentation region of the first object includes the following operations:

performing the core segmentation processing on an object slice image group through the core segmentation network to obtain a core segmentation region of the first object on an object slice image, where the object slice image group includes the object slice image and 2N slice images adjacent to the object slice image, the object slice image is any one of the multiple slice images, and N is a positive integer.

The core segmentation region of the first object is determined according to core segmentation regions of the multiple slice images.

For example, for any slice image (hereinafter referred to the object slice image, such as a 192*192 cross-sectional slice image) in the to-be-processed image, the object slice image and N slice images upwardly and downwardly adjacent to the object slice image (i.e., 2N+1 slice images) form the object slice image group. The 2N+1 slice images in the object slice image group are input to the core segmentation network for processing to obtain the core segmentation region of the object slice image. For example, N is 4 that is, four slice images upwardly and downwardly adjacent to each slice image and nine slice images in total are selected. If the number of slice images upwardly or downwardly adjacent to the object slice image is greater than or equal to N, the slice images are directly selected, for example, if the object slice image is numbered as 6, nine adjacent slice images numbered as 2, 3, 4, 5, 6, 7, 8, 9 and 10 are selected; and if the number of slice images upwardly or downwardly adjacent to the object slice image is smaller than N, a filling manner is used for completion, for example, if the object slice image is numbered as 3 and there are two upwardly adjacent images, the upwardly adjacent images are symmetrically filled, that is, nine adjacent slice images numbered as 3, 2, 1, 2, 3, 4, 5, 6 and 7 are selected. There are no limits made on the value of the N and the specific image completion manner in the disclosure.

In some embodiments of the disclosure, by respectively processing the slice images in the to-be-processed image, segmentation regions of multiple slice images are obtained. By searching connected domains for the core segmentation regions of the multiple slice images, the core segmentation region of the first object in the to-be-processed image may be determined.

In this way, the core segmentation on the to-be-processed image may be implemented, thereby detecting and localizing a core of each vertebra.

In some embodiments of the disclosure, the step that the core segmentation region of the first object is determined according to the core segmentation regions of the multiple slice images includes the following operations:

determining multiple 3D core segmentation regions respectively according to the core segmentation regions of the multiple slice images;

optimizing the multiple 3D core segmentation regions to obtain the core segmentation region of the first object.

For example, for a 3D vertebral image, multiple 3D core segmentation regions are obtained by overlapping plane core segmentation regions of multiple slice images of the vertebral image and searching connected domains in the overlapped core segmentation regions , wherein each connected domain corresponding to one 3D vertebral core. Then, the multiple 3D core segmentation regions are optimized to remove foreign regions to obtain a core segmentation region of a first object, wherein the volume of the connected region is less than or equal to a preset volume threshold. There are no limits made on the specific value of the preset volume threshold in the disclosure. In this way, the accuracy of core segmentation on the vertebra is improved.

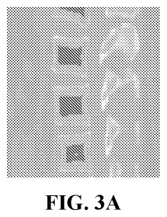

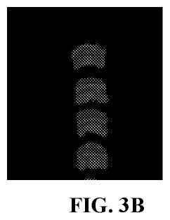

FIG. 3A is a schematic diagram of core segmentation of an image processing method provided by an embodiment of the disclosure. FIG. 3B is another schematic diagram of core segmentation of an image processing method provided by an embodiment of the disclosure. As shown in FIG. 3A and FIG. 3B, upon the core segmentation, cores of multiple vertebras (i.e., multiple core segmentation regions) may be obtained to implement the localization on each vertebra.

In some embodiments, the method further includes the following operation:

determining a central point position of each segmentation region according to the segmentation regions of the objects in the to-be-processed image.

In the embodiment of the disclosure, after the first segmentation processing is performed on the to-be-processed image, the segmentation regions of the objects in the to-be-processed image include at least one segmentation region; and in a case where the segmentation regions of the objects in the to-be-processed image include multiple segmentation regions, the central point position of each segmentation region is determined. Each segmentation region represents the segmentation region of each object in the to-be-processed image.

For example, upon the determination of the segmentation regions of the objects in the to-be-processed image, a position where a geometric center of each segmentation region is located, i.e., the central point position, is determined. Various mathematical computation manners are used to determine the central point position, and there are no limits made thereto in the disclosure. In this way r, the central point positions of the segmentation regions of the objects can be determined.

In some embodiments, the method further includes the following operations:

determining an initial central point position of each segmentation region according to the segmentation regions of the objects in the to-be-processed image.

The initial central point positions of the segmentation regions of the objects are optimized to determine the central point position of each segmentation region.

For example, after the segmentation regions of the objects in the to-be-processed image are determined, a position of a geometric center of each segmentation region is determined, and the position is used as the initial central point position. Various mathematical computation manners are used to determine the initial central point position, and there are no limits made thereto in the disclosure.

In some embodiments of the disclosure, after each initial central point position is determined, validation check is performed on each initial central point position, so as to check missed segmentation and/or excessive segmentation and make optimizations.

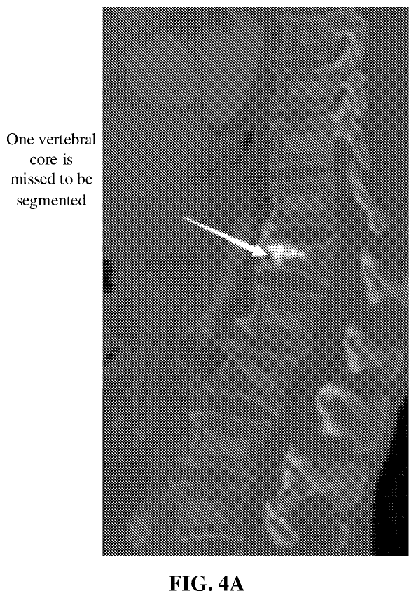

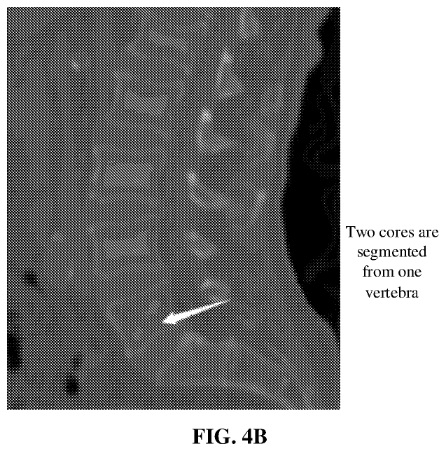

FIG. 4A is a schematic diagram of core segmentation with missed segmentation in an image processing method provided by an embodiment of the disclosure. FIG. 4B is a schematic diagram of core segmentation with excessive segmentation in an image processing method provided by an embodiment of the disclosure. As shown in FIG. 4A, one vertebral core is missed to be segmented, i.e., the vertebral core is not segmented at the position of the vertebra; and as shown in FIG. 4B, there is the vertebral core that is excessively segmented, i.e., two cores are segmented from one vertebra.

For the situations of the missed segmentation and the excessive segmentation shown in FIG. 4A and FIG. 4B, the initial central point positions of the segmentation regions of the objects are optimized to finally determine the central point position of each segmentation region.

In some embodiments of the disclosure, for the implementation manner for performing the validation check and optimization on each initial central point position, a distance d between two adjacent geometric center pairs (i.e., adjacent initial center positions) and an average distance dₘ are calculated for each initial central point position, and a Neighbor Threshold (NT) and a Global Threshold (GT) are set as references. Each geometric center pair is traversed from top to bottom or from bottom to top; and for an i-th geometric center pair among M geometric center pairs (1≤i≤M), in case of dᵢ/dₘ>GT or dᵢ/dᵢ₋₁>NT, it is considered that the distance between the i-th geometric center pair is excessively large, and determined that there is the missed segmentation between the i-th geometric center pair (as shown in FIG. 4A), the dᵢ/representing the distance between the i-th geometric center pair. In this case, the central point between the geometric center pair is added as a new geometric center (i.e., a new central point position) to implement optimization on the central point position.

In some embodiments of the disclosure, for the implementation manner for performing the validation check and optimization on each initial central point position, with regard to each initial central point position and an i-th geometric center pair, in case of dᵢ/dₘ<1/GT or dᵢ/dᵢ₋₁<1/NT, it is considered that the distance between the i-th geometric center pair is excessively small, and determined that there is the excessive segmentation between the i-th geometric center pair (as shown in FIG. 4B). In this case, the mid-point between the geometric center pair is used as a new geometric center, and the geometric center pair is deleted, to implement optimization on the central point position.

In some embodiments of the disclosure, for the geometric center pair without the above situations among the geometric center pairs, corresponding central points of these geometric center pairs are retained, and not be processed. The NT and the GT are, for example, 1.5 and 1.8 respectively. It is to be understood that both the NT and the GT are set by the person skilled in the art according to an actual situation, and there are no limits made thereto in the disclosure.

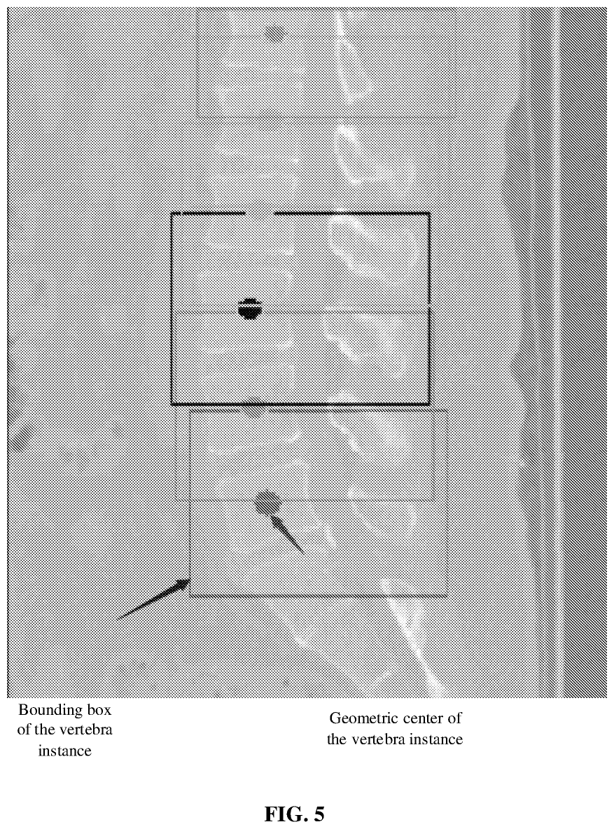

FIG. 5 is a schematic diagram of a central point of an object segmentation region in an image processing method provided by an embodiment of the disclosure. As shown in FIG. 5, in the case where the to-be-processed image includes the 3D vertebral image, after the central point positions of the object segmentation regions are determined and optimized, a central point position of each vertebral core (i.e., a vertebral instance geometric center) is determined, so as to facilitate the processing in subsequent steps to obtain an image region defined by a vertebral instance bounding box. In this way, the processing accuracy is improved.

In some embodiments of the disclosure, in step S12, according to the central point positions of the segmentation regions of the objects, the image regions where the objects are located, i.e., ROIs defined by bounding boxes, are determined. Step S12 includes the following operations:

determining the image region where the object is located for any object according to a central point position of the object and at least one central point position adjacent to the central point position of the object.

For example, each object belonging to the first class (i.e., each first object) may be processed. For any object Vₖ(1≤k≤K, for example, arranged from bottom to top) in K first objects, a central point position of the object may be set as C(Vₖ). In case of 1<k<K, the cross section where two central point positions C(Vₖ₊₁) and C(Vₖ₋₁) adjacent to the object upwardly and downwardly are located are used as the boundary of the object, thereby determining the ROI defined by the bounding box of the object Vₖ, i.e., C(Vₖ₊₁)−C(Vₖ₋₁)+1 continuous cross-sectional slice images are used as the ROI of the object Vₖ.

In some embodiments of the disclosure, for the object V_{K} on the topmost layer, as the central point adjacent to the object upwardly is missed, symmetrical boundaries of the central point C(V_{K}) of the downwardly adjacent central point C(V_{K-1}) relative to V_{K} may be used, i.e., a distance C(V_{K})−C(V_{K-1}) is extended upwardly. The cross section where the position is located is used as the upper boundary of the object V_{K} and the cross section where the central point C(V_{K-1}) is located is used as the lower boundary of the object V_{K}, thereby determining the ROI defined by the bounding box of the object Vₖ, i.e., 2*(C(V_{K})−C(V_{K-1}))+1 continuous cross-sectional slice images are used as the ROI of the object Vₖ.

In some embodiments of the disclosure, for the object V₁ on the bottommost layer, as the central point adjacent to the object downwardly is missed, symmetrical boundaries of the central point C(V₁) of the upwardly adjacent central point C(V₂) relative to V₁ is used, i.e., a distance C(V₂)−C(V₁) is extended downwardly. The cross section where the position is located is used as the lower boundary of the object V₁ and the cross section where the central point C(V₂) is located is used as the upper boundary of the object V₁, thereby determining the ROI defined by the bounding box of the object V₁, i.e., 2*(C(V₂)−C(V₁))+1 continuous cross-sectional slice images are used as the ROI of the object V₁. As shown in FIG. 5, with processing, the image region where the first object is located, i.e., the ROI defined by the bounding box, is determined.

In some embodiments of the disclosure, in a case where the class of each first object is the spine, in order to cope with the abnormal condition of a long spinous process, the lower boundary of the bounding box of each first object is extended downwardly, for example, by a half of 0.15*the length of the boundary of the spine, i.e., 0.15*(C(Vₖ₊₁)−C(Vₖ₋₁))/2. It is to be understood that the length of the downwardly extended boundary is set by the person skilled in the art according to an actual situation, and there are no limits made thereto in the disclosure.

In this way, the boundary box of each object is determined, such that the ROI defined by the bounding box may be determined to implement accurate localization of the vertebra.

In some embodiments of the disclosure, the segmentation results of the objects include a segmentation result of the first object, and step S13 includes: instance segmentation is respectively performed, through a first instance segmentation network, on the image region where the first object is located to determine the segmentation result of the first object.

For example, the first instance segmentation network is preset to facilitate the instance segmentation on the image region where the first object is located (i.e., the ROI). For example, the first instance segmentation network is the convolutional neutral network and use a 3D segmentation network model based on U-Net. There are no limits made on the structure of the first instance segmentation network in the disclosure.

In some embodiments of the disclosure, for a slice image in any ROI (such as a 192*192 cross-sectional slice image), the slice image and N slice images upwardly and downwardly adjacent to the slice image (i.e., 2N+1 slice images) form a slice image group. The 2N+1 slice images in the slice image group are input to the first instance segmentation network for processing to obtain the instance segmentation region of the slice image. The N is 4 for example, that is, four slice images upwardly and downwardly adjacent to each slice image and nine slice images in total are selected. In a case where the number of upwardly or downwardly adjacent slice images is smaller than N, a symmetrical filling manner may be used for completion, which is not repeatedly described herein. There are no limits made on the specific value of the N and the image completion manner in the disclosure.

In some embodiments of the disclosure, by respectively processing multiple slice images in each ROI, instance segmentation regions for the multiple slice images of each ROI are obtained. Plane instance segmentation regions of the multiple slice images are overlapped, and connected domains in the overlapped 3D instance segmentation regions are searched, each connected domain corresponding to one 3D instance segmentation region. Then, the multiple 3D instance segmentation regions are optimized to remove foreign regions of which the connected domains have the volume smaller than or equal to a preset volume threshold, thereby obtaining one or more instance segmentation regions of the first object; and the one or more instance segmentation regions of the first object are used as a segmentation result of the first object. There are no limits made on the specific value of the preset volume threshold in the disclosure.

In this way, the instance segmentation on each vertebral object is implemented, and the accuracy of instance segmentation on the vertebra is improved.

In some embodiments of the disclosure, the segmentation regions of the objects in the to-be-processed image include a segmentation region of the second object, the second object is an object belonging to a second class in the objects, and step S11 includes: performing, through a second instance segmentation network, the instance segmentation on the to-be-processed image to determine the segmentation result of the second object.

For example, the class of the second object includes a caudal vertebra. As the caudal vertebra is greatly different from other objects in features, the instance segmentation is directly performed to obtain the segmentation result. The second instance segmentation network is preset to facilitate the instance segmentation on the preprocessed to-be-processed image. For example, the second instance segmentation network is the convolutional neutral network, use a 2.5D segmentation network model based on U-Net, and include a residual encoding network (such as Resnet34), an Atrous Spatial Pyramid Pooling (ASPP) module, an attention-based module, a decoder, etc. There are no limits made on the structure of the second instance segmentation network in the disclosure.

In some embodiments of the disclosure, for the segmentation of the caudal vertebra, the spatial resolution ratio of the to-be-processed image is adjusted to 0.4*0.4*1.25 mm³ by resampling; the pixel value of the resampled image is reduced to [−1, inf]; and then, with the center of the first image as a reference position, each slice image of the first image is cropped into a 512*512 image, and the pixel value at the position insufficient to 512*512 is filled as −1. In this way, the preprocessed image may be obtained.

In some embodiments of the disclosure, for any slice image in the preprocessed image, the slice image and N slice images upwardly and downwardly adjacent to the slice image (i.e., 2N+1 slice images) may form a slice image group. The 2N+1 slice images in the slice image group are input to the second instance segmentation network for processing to obtain the instance segmentation region of the slice image. The N is 4 for example, i.e., four slice images upwardly and downwardly adjacent to each slice image and nine slice images in total are selected. In a case where the number of upwardly or downwardly adjacent slice images is smaller than N, a symmetrical filling manner is used for completion, which is not repeatedly described herein. There are no limits made on the specific value of the N and the image completion manner in the disclosure.

In some embodiments of the disclosure, by respectively processing each slice image, segmentation regions of multiple slice images is obtained. Plane instance segmentation regions of the multiple slice images are overlapped, and connected domains in the overlapped 3D instance segmentation regions are searched, each connected domain corresponding to one 3D instance segmentation region. Then, the 3D instance segmentation regions are optimized to remove foreign regions of which the connected domains have the volume smaller than or equal to a preset volume threshold, thereby obtaining the instance segmentation region of the second object; and the instance segmentation region is used as a segmentation result of the first object. There are no limits made on the specific value of the preset volume threshold in the disclosure.

In this way, the instance segmentation on a special vertebral object is implemented, and the accuracy of instance segmentation on the vertebra is improved.

In some embodiments, the method further includes the following operation:

determining a fused segmentation result of the objects in the to-be-processed image by fusing the segmentation result of the first object and the segmentation result of the second object.

For example, in the foregoing steps, the instance segmentation results of the first object (for example, the class is the lumbar vertebra) and the second object (for example, the class is the caudal vertebra) are respectively obtained. However, there is a certain overlapping region between the two instance segmentation results. For example, the core segmentation on the lumbar vertebra has the excessive segmentation to result in that a part of caudal vertebra is wrongly segmented as the lumbar vertebra; or the instance segmentation on the caudal vertebra has the excessive segmentation to result in that a part of lumbar vertebra is wrongly segmented as the caudal vertebra.

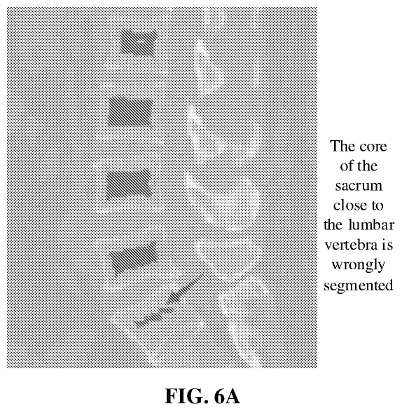

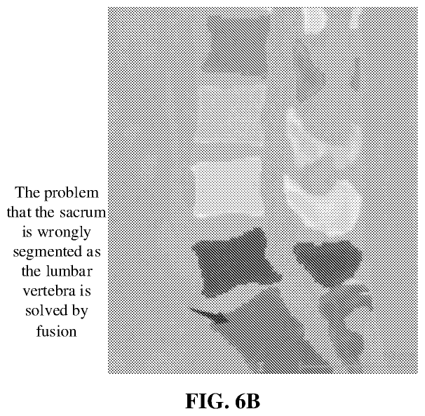

FIG. 6A is a schematic diagram of a segmentation region with wrong segmentation in an image processing method provided by an embodiment of the disclosure. As shown in FIG. 6A, during the core segmentation of the lumbar vertebra, the core part of the sacrum of the caudal vertebra close to the lumbar vertebra is wrongly segmented as the lumbar vertebra. FIG. 6B is a schematic diagram of a segmentation region after correction of a wrong segmentation situation shown in FIG. 6A in an embodiment of the disclosure. As shown in FIG. 6B, the fusion is performed on the segmentation result of the first object and the segmentation result of the second object to solve the problem that the sacrum of the caudal vertebra is wrongly segmented as the lumbar vertebra in FIG. 6A.

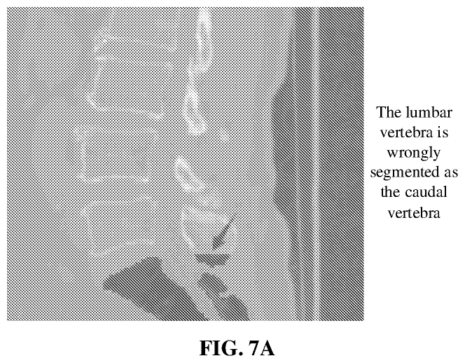

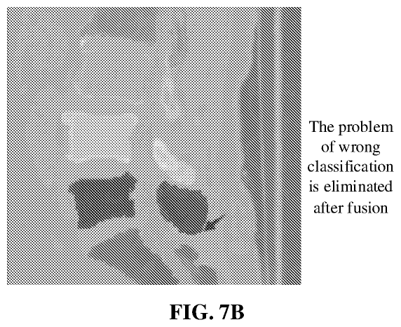

FIG. 7A is a schematic diagram of another segmentation region with wrong segmentation in an image processing method provided by an embodiment of the disclosure. As shown in FIG. 7A, during the instance segmentation of the caudal vertebra, the lumbar vertebra is wrongly identified as the caudal vertebra. FIG. 7B is a schematic diagram of a segmentation region after correction of a wrong segmentation situation shown in FIG. 7A in an embodiment of the disclosure. As shown in FIG. 7B, the fusion is performed on the segmentation result of the first object and the segmentation result of the second object to solve the problem that the lumbar vertebra is wrongly classified as the caudal vertebra in FIG. 7A.

Exemplary descriptions are made below on the implementation manner for performing the fusion on the segmentation result of the first object and the segmentation result of the second object.

In some embodiments of the disclosure, the fusion is performed on the instance segmentation results of the first object and the second object to determine the class to which the overlapping portion therebetween belongs. For multiple instance segmentation regions of the first object (such as the lumbar vertebra), an Intersection Over Union (IOU) between each instance segmentation region of the first object and the instance segmentation region E of the second object are respectively calculated. For any instance segmentation region Wⱼ (1≤j≤J, the J being the number of instance segmentation regions of the first object) of the first object, the IOU with the instance segmentation region E of the second object is IOU (W_{J},E).

In some embodiments of the disclosure, a threshold T is preset. In case of IOU(Wⱼ,E)>T, the instance segmentation region Wⱼ is a wrong segmentation result of the second object (i.e., the caudal vertebra) and should belong to the caudal vertebra. As shown in FIG. 6B, the instance segmentation region Wⱼ is incorporated into the instance segmentation region E of the second object to solve the problem that the caudal vertebra is wrongly segmented as the lumbar vertebra.

In some embodiments of the disclosure, in case of 0<IOU(Wⱼ, E)<T, the instance segmentation region E of the second object has the excessive segmentation and should belong to the lumbar vertebra. As shown in FIG. 7B, the instance segmentation region E is incorporated into the instance segmentation region Wⱼ to solve the problem that the lumbar vertebra is wrongly segmented as the caudal vertebra.

In some embodiments of the disclosure, in case of IOU(Wⱼ,E)=0, both the instance segmentation region Wⱼ and the instance segmentation region E are not processed. The T may be, for example, 0.2. It is to be understood that the threshold T is set by the person skilled in the art according to an actual situation, and there are no limits made thereto in the disclosure. In this way, a more accurate vertebra segmentation result is obtained, and the segmentation effect is improved.

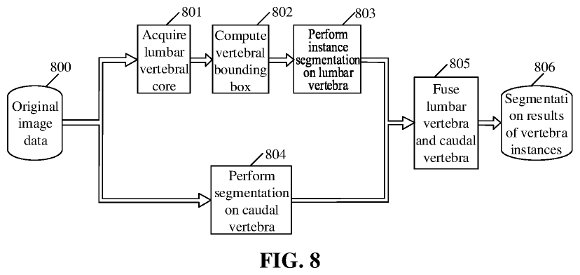

FIG. 8 is a schematic diagram of a processing process of an image processing method provided by an embodiment of the disclosure. With the localization and segmentation of the vertebra as an example below, the processing process according to the image processing method in the embodiment of the disclosure is described. As shown in FIG. 8, lumbar vertebra segmentation and caudal vertebra segmentation are respectively performed on the original image data (i.e., the 3D vertebral image).

Referring to FIG. 8, on one hand, step 801 to step 803 are sequentially executed on the preprocessed original image data 800 (such as multiple 192*192 slice images or multiple 512*512 slice images).

S801: acquiring a lumbar vertebral core.

Herein, the original image data 800 is input to the core segmentation network 801 for core segmentation to obtain each lumbar vertebral core (as shown in FIG. 3A).

S802: calculating a vertebral bounding box.

Herein, for each acquired lumbar vertebral core, a geometric center position of each lumbar vertebral core is calculated, thereby calculating the vertebral bounding box of each lumbar vertebral core.

S803: performing an instance segmentation on a lumbar vertebra.

Herein, the ROI defined by each vertebral bounding box is input to the first instance segmentation network for instance segmentation on the lumbar vertebra to obtain the instance segmentation result of the lumbar vertebra.

On the other hand, step 804 is executed on the preprocessed original image data 800.

S804: performing the segmentation on a caudal vertebra.

Herein, the preprocessed original image data is input to the second instance segmentation network for segmentation on the caudal vertebra to obtain an instance segmentation result of the caudal vertebra.

In some embodiments of the disclosure, features are extracted from the original image data based on a deep learning architecture, thereby implementing the subsequent core segmentation processing. Based on the deep learning architecture, the optimal feature representation can be learn from the original image, which is helpful to improve the accuracy of core segmentation. In some embodiments of the disclosure, referring to FIG. 8, after the execution of step 803 and step 804, step 805 may be executed.

S805: fusing the lumbar vertebra (i.e., the instance segmentation result of the lumbar vertebra) and the caudal vertebra (i.e., the instance segmentation result of the caudal vertebra) to obtain a final vertebra instance segmentation result 806 (as shown in FIG. 6B and FIG. 7B).

In this way, the vertebras can be localized to determine the bounding box of each vertebra; the ROIs are intercepted through the bounding boxes to implement the instance segmentation on the vertebras; the caudal vertebra having geometric properties different from other vertebras is independently segmented; and the instance segmentation results are fused. Therefore, the accuracy and robustness of segmentation are improved.

In some embodiments of the disclosure, before applying or deploying the above neutral network, each neutral network is trained. In the embodiment of the disclosure, the method for training the neutral network further includes the following operation:

training the neutral network according to a preset training set, where the neutral network includes at least one of the core segmentation network, the first instance segmentation network or the second instance segmentation network, and the training set includes multiple annotated sample images.

For example, the training set is preset to train the core segmentation network, the first instance segmentation network and the second instance segmentation network.

In some embodiments of the disclosure, for the core segmentation network, each vertebra in the sample image (i.e., the 3D vertebral image) is annotated first (as shown in FIG. 6B), and then corroded by a spherical structural element having a radius of 1 till the core volume/vertebra volume<=0.15, thereby determining core annotation information of the sample image (as shown in FIG. 3A). There are no limits made on the threshold of a ratio of the core volume to the vertebra volume in the disclosure.

In some embodiments of the disclosure, the core segmentation network is trained according to the sample images and core annotation information thereof. The training process of the core segmentation network is, for example, monitored by a cross entropy loss function and a similarity loss function (dice); and upon training, the core segmentation network meeting requirements is obtained.

In some embodiments of the disclosure, for the first instance segmentation network, a geometric center of the vertebra is calculated according to core annotation information of the sample images; and with the geometric center of the upper vertebra adjacent to the present vertebra as an upper boundary and that the geometric center of the lower adjacent vertebra is downwardly extended with 0.15*thickness of the vertebra (i.e., a half of a difference between upper and lower boundaries of the bounding box of the vertebra) as a lower boundary, continuous cross-sectional slices intercepted from a z axis at the upper and lower boundaries are used as ROIs of the present vertebra. During test, the geometric center of the vertebra that is calculated according to the segmentation result of the core segmentation network is often offset from a real geometric center. In order to enhance the robustness of the model, certain random disturbance may be made to upper and lower boundaries of the vertebra. The disturbance has a value in a range [−0.1*thickness of the vertebra, 0.1*thickness of the vertebra].

In some embodiments of the disclosure, each ROI is input to the first instance segmentation network for processing, and the first instance segmentation network is trained according to the processing result and the annotation information of the sample images (i.e., each annotated vertebra). The training process of the first instance segmentation network is, for example, monitored by a cross entropy loss function and a similarity loss function (dice); and upon training, the first instance segmentation network meeting requirements is obtained.

In some embodiments of the disclosure, for the second instance segmentation network, the caudal vertebras in the sample images is annotated, and the second instance segmentation network is trained according to the sample images and the caudal vertebra annotated information thereof. The training process of the second instance segmentation network is, for example, monitored by a cross entropy loss function and a similarity loss function; and upon training, the second instance segmentation network meeting requirements is obtained.

In some embodiments of the disclosure, the neutral networks are respectively trained, and the neutral networks are also jointly trained, and there are no limits made on the training manner and specific training process in the disclosure.

In this way, the training process of each of the core segmentation network, the first instance segmentation network and the second instance segmentation network are implemented to obtain the high-precision neutral network.

According to the image processing method in the embodiment of the disclosure, the detection and localization on the vertebras are implemented, the bounding box of each vertebra is determined, the ROIs are intercepted by the bounding boxes to implement the instance segmentation on the vertebras, the caudal vertebra is independently segmented, and the instance segmentation results are fused. Therefore, the instance segmentation on all classes of vertebras (including the caudal vertebra, the lumbar vertebra, the thoracic vertebra and the cervical vertebra) is implemented, the robustness on the number of vertebras and the scanning parts is strong, the time consumption is small, and the requirements on timeliness are met.

It can be understood that the method embodiments mentioned in the disclosure may be combined with each other to form a combined embodiment without departing from the principle and logic, which is not elaborated in the embodiments of the disclosure for the sake of simplicity. It can be understood by those skilled in the art that in the method of the specific implementation modes, the specific execution sequence of each step may be determined in terms of the function and possible internal logic.

In addition, the disclosure further provides an image processing apparatus, an electronic device, a computer readable storage medium and a program, all of which may be configured to implement any image processing method provided by the disclosure. The corresponding technical solutions and descriptions refer to the corresponding descriptions in the method and will not elaborated herein.

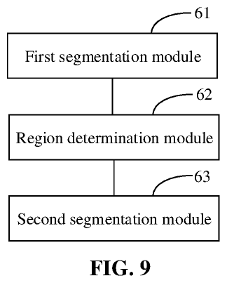

FIG. 9 is a structure diagram of an image processing apparatus provided by an embodiment of the disclosure. As shown in FIG. 9, the image processing apparatus includes: a first segmentation module 61, configured to perform a first segmentation processing on a to-be-processed image to determine segmentation regions of objects in the to-be-processed image; a region determination module 62, configured to determine, according to central point positions of the segmentation regions of the objects, image regions where the objects are located; and a second segmentation module 63, configured to perform a second segmentation processing on the image regions where the objects are located to determine segmentation results of the objects in the to-be-processed image.

In some embodiments of the disclosure, the segmentation regions of the objects in the to-be-processed image include a core segmentation region of a first object, the first object is an object belonging to a first class in the objects, and the first segmentation module includes: a core segmentation sub-module, configured to perform a core segmentation processing on the to-be-processed image through a core segmentation network to determine a core segmentation region of the first object.

In some embodiments of the disclosure, the segmentation results of the objects include a segmentation result of the first object, and the second segmentation module includes: a first instance segmentation sub-module, configured to respectively perform, through a first instance segmentation network, an instance segmentation on the image region where the first object is located to determine the segmentation result of the first object.

In a possible implementation manner, the segmentation regions of the objects in the to-be-processed image include a segmentation region of a second object, the second object is an object belonging to a second class in the objects, and the first segmentation module includes: a second instance segmentation sub-module, configured to perform, through a second instance segmentation network, the instance segmentation on the to-be-processed image to determine the segmentation result of the second object.

In some embodiments of the disclosure, the apparatus further includes: a fusion module, configured to determine a fused segmentation result of the objects in the to-be-processed image by fusing the segmentation result of the first object and the segmentation result of the second object.

In some embodiments of the disclosure, the to-be-processed image includes a 3D vertebral image, the 3D vertebral image includes multiple slice images in a cross-sectional direction of a vertebra, and the core segmentation sub-module includes: a slice segmentation sub-module, configured to perform the core segmentation processing on an object slice image group through the core segmentation network to obtain a core segmentation region of the first object on an object slice image, where the object slice image group includes the object slice image and 2N slice images adjacent to the object slice image, the object slice image is any one of the multiple slice images, and N is a positive integer; and a core region determination sub-module, configured to determine the core segmentation region of the first object according to core segmentation regions of the multiple slice images.

In some embodiments of the disclosure, the core region determination sub-module is configured to: determine multiple 3D core segmentation regions respectively according to the core segmentation regions of the multiple slice images; and optimize the multiple 3D core segmentation regions to obtain the core segmentation region of the first object.

In some embodiments of the disclosure, the apparatus further includes: a first center determination module, configured to determine a central point position of each segmentation region according to the segmentation regions of the objects in the to-be-processed image.

In some embodiments of the disclosure, the apparatus further includes: a second center determination module, configured to determine initial central point positions of the segmentation regions of the objects according to the segmentation regions of the objects in the to-be-processed image; and a third center determination module, configured to optimize the initial central point positions of the segmentation regions of the objects to determine the central point position of each segmentation region.

In some embodiments of the disclosure, the first segmentation module includes: an adjustment sub-module, configured to perform resampling and pixel value reduction on the to-be-processed image to obtain a processed first image; a crop sub-module, configured to perform a central crop on the first image to obtain a cropped second image; and a segmentation sub-module, configured to perform the first segmentation processing on the second image to determine the segmentation regions of the objects in the to-be-processed image.

In some embodiments of the disclosure, the region determination module includes: an image region determination sub-module, configured to determine, for any object, the image region where the object is located according to a central point position of the object and at least one central point position adjacent to the central point position of the object.

In some embodiments of the disclosure, the apparatus further includes: a training module, configured to train a neutral network according to a preset training set, where the neutral network includes at least one of the core segmentation network, the first instance segmentation network or the second instance segmentation network, and the training set includes multiple annotated sample images.

In some embodiments of the disclosure, the first class includes at least one of a cervical vertebra, a spine, a lumbar vertebra or a thoracic vertebra; and the second class includes a caudal vertebra.

In some embodiments, the function or included module of the apparatus provided by the embodiment of the present disclosure may be configured to implement the method described in the above method embodiments, and the specific implementation may refer to the description in the above method embodiments. For the simplicity, the details are not elaborated herein.

The embodiments of the disclosure further provide a computer-readable storage medium having stored thereon computer program instructions that, when executed by a processor, cause any image processing method above to be implemented. The computer-readable storage medium may be a non-volatile computer-readable storage medium.

The embodiments of the disclosure further provide an electronic device, which includes: a processor; and a memory, configured to store instructions executable by the processor; and the processor is configured to call the instructions stored in the memory to implement any image processing method above.

The electronic device is provided as a terminal, a server or other types of devices.

The embodiments of the disclosure further provide a computer program including computer-readable codes that, when run in an electronic device, cause a processor in the electronic device to implement any image processing method above.

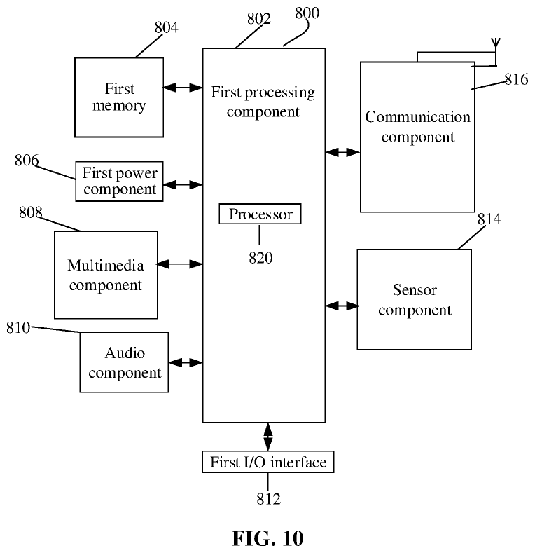

FIG. 10 is a structure diagram of an electronic device 800 provided by an embodiment of the disclosure. For example, the electronic device 800 is a terminal such as a mobile phone, a computer, a digital broadcast terminal, a messaging device, a gaming console, a tablet, a medical device, exercise equipment and a PDA.

Referring to FIG. 10, the electronic device 800 includes one or more of the following components: a first processing component 802, a first memory 804, a first power component 806, a multimedia component 808, an audio component 810, a first Input/Output (I/O) interface 812, a sensor component 814, and a communication component 816.

The first processing component 802 typically controls overall operations of the electronic device 800, such as the operations associated with display, telephone calls, data communications, camera operations, and recording operations. The first processing component 802 includes one or more processors 820 to execute instructions to perform all or part of the steps in the above described methods. Moreover, the first processing component 802 includes one or more modules which facilitate the interaction between the first processing component 802 and other components. For instance, the first processing component 802 includes a multimedia module to facilitate the interaction between the multimedia component 808 and the first processing component 802.

The first memory 804 is configured to store various types of data to support the operation of the electronic device 800. Examples of such data include instructions for any application or method operated on the electronic device 800, contact data, phonebook data, messages, pictures, videos, etc. The first memory 804 is implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The first power component 806 provides power to various components of the electronic device 800. The first power component 806 includes a power management system, one or more power sources, and any other components associated with the generation, management, and distribution of power in the electronic device 800.

The multimedia component 808 includes a screen providing an output interface between the electronic device 800 and the user. In some embodiments, the screen includes a Liquid Crystal Display (LCD) and a Touch Panel (TP). If the screen includes the TP, the screen is implemented as a touch screen to receive an input signal from the user. The TP includes one or more touch sensors to sense touches, swipes and gestures on the TP. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera receives external multimedia data when the electronic device 800 is in an operation mode, such as a photographing mode or a video mode. Each of the front camera and the rear camera is a fixed optical lens system or have focus and optical zoom capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signal is stored in the first memory 804 or transmitted via the communication component 816. In some embodiments, the audio component 810 further includes a speaker configured to output audio signals.

The first I/O interface 812 provides an interface between the first processing component 802 and peripheral interface modules. The peripheral interface modules is a keyboard, a click wheel, buttons, and the like. The buttons include, but are not limited to, a home button, a volume button, a starting button, and a locking button.

The sensor component 814 includes one or more sensors to provide status assessments of various aspects of the electronic device 800. For instance, the sensor component 814 detects an on/off status of the electronic device 800 and relative positioning of components, such as a display and small keyboard of the electronic device 800, and the sensor component 814 further detects a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 includes a proximity sensor, configured to detect the presence of nearby objects without any physical contact. The sensor component 814 also includes a light sensor, such as a Complementary Metal Oxide Semiconductor (CMOS) or Charge Coupled Device (CCD) image sensor, configured for use in an imaging application. In some embodiments, the sensor component 814 also includes an accelerometer sensor, a gyroscope sensor, a magnetic sensor, a pressure sensor, or a temperature sensor.

The communication component 816 is configured to facilitate wired or wireless communication between the electronic device 800 and another device. The electronic device 800 accesses a communication-standard-based wireless network, such as a Wireless Fidelity (WiFi) network, a 2nd-Generation (2G) or 3rd-Generation (3G) network or a combination thereof. In one exemplary embodiment, the communication component 816 receives a broadcast signal or broadcast associated information from an external broadcast management system via a broadcast channel In one exemplary embodiment, the communication component 816 further includes a Near Field Communication (NFC) module to facilitate short-range communications. For example, the NFC module is implemented based on a Radio Frequency Identification (RFID) technology, an Infrared Data Association (IrDA) technology, an Ultra-Wideband (UWB) technology, a Bluetooth (BT) technology, and other technologies.

In the exemplary embodiment, the electronic device 800 is implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to implement the above method.

In an exemplary embodiment, a non-volatile computer-readable storage medium, for example, a first memory 804 including a computer program instruction, is also provided. The computer program instruction is executed by a processor 820 of an electronic device 800 to implement the above method.

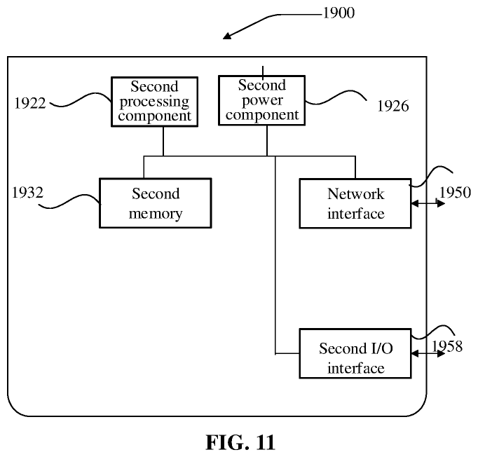

FIG. 11 is a structure diagram of an electronic device 1900 provided by an embodiment of the disclosure. For example, the electronic device 1900 is provided as a server. Referring to FIG. 11, the electronic device 1900 includes a second processing component 1922, further including one or more processors, and a memory resource represented by a second memory 1932, configured to store instructions executable by the second processing component 1922, for example, an application program. The application program stored in the second memory 1932 includes one or more modules, with each module corresponding to one group of instructions. In addition, the second processing component 1922 is configured to execute the instruction to implement the above method.

The electronic device 1900 further includes a second power component 1926 configured to perform power management of the electronic device 1900, a wired or wireless network interface 1950 configured to connect the electronic device 1900 to a network and a second I/O interface 1958. The electronic device 1900 is operated based on an operating system stored in the second memory 1932, for example, Windows Server™, Mac OS X™, Unix™, Linux™, FreeBSD™ or the like.

In an exemplary embodiment, a non-volatile computer-readable storage medium, for example, a second memory 1932 including a computer program instruction, is also provided. The computer program instruction is executed by a second processing component 1922 of an electronic device 1900 to implement the above method.

The disclosure relates to a system, a method and/or a computer program product. The computer program product includes a computer-readable storage medium, in which a computer-readable program instruction configured to enable a processor to implement each aspect of the present disclosure is stored.

The computer-readable storage medium is a physical device capable of retaining and storing an instruction used by an instruction execution device. The computer-readable storage medium is, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instructions stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here is downloaded from the computer-readable storage medium to each computing/processing device or downloaded to an external computer or an external storage device through a network such as an Internet, a Local Area Network (LAN), a Wide Area Network (WAN) and/or a wireless network. The network includes a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure is an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction is completely or partially executed in a computer of a user, executed as an independent software package, executed partially in the computer of the user and partially in a remote computer, or executed completely in the remote server or a server. In a case involved in the remote computer, the remote computer is connected to the user computer via any type of network including the Local Area Network (LAN) or the Wide Area Network (WAN), or, is connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instruction. The electronic circuit executes the computer-readable program instruction to implement each aspect of the disclosure.

Herein, each aspect of the embodiments of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams is implemented by computer-readable program instructions.

These computer-readable program instructions is provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions is also stored in a computer-readable storage medium, and through these instructions, the computer, the programmable data processing device and/or another device work in a specific manner, so that the computer-readable medium including the instructions includes a product including instructions for implementing each aspect of the function/action specified in one or more blocks in the flowcharts and/or the block diagrams.

These computer-readable program instructions are loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams represents part of a module, a program segment or an instruction, and part of the module, the program segment or the instruction includes one or more executable instructions configured to realize a specified logical function. In some alternative implementations, the functions marked in the blocks are also realized in a sequence different from those marked in the drawings. For example, two continuous blocks are actually executed in a substantially concurrent manner and are also executed in a reverse sequence sometimes, which is determined by the involved functions. It is further to be noted that each block in the block diagrams and/or the flowcharts and a combination of the blocks in the block diagrams and/or the flowcharts are implemented by a dedicated hardware-based system configured to execute a specified function or operation or are implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the present disclosure. The terms used herein are selected to explain the principle and practical application of each embodiment or technical improvements in the technologies in the market best or enable others of ordinary skill in the art to understand each embodiment disclosed herein.

### INDUSTRIAL APPLICABILITY

The disclosure relates to the image processing method and apparatus, the electronic device, the storage medium and the computer program. The method includes: a first segmentation processing is performed on a to-be-processed image to determine segmentation regions of objects in the to-be-processed image; image regions where the objects are located are determined according to central point positions of the segmentation regions of the objects; and a second segmentation processing is performed on the image regions where the objects are located to determine segmentation results of the objects in the to-be-processed image. The embodiments of the disclosure implement the instance segmentation on the objects, and improve the accuracy and robustness of segmentation.

1. A method, comprising:
performing a first segmentation processing on a to-be-processed image to determine segmentation regions of objects in the to-be-processed image;
determining, according to central point positions of the segmentation regions of the objects, image regions where the objects are located; and
performing a second segmentation processing on the image regions where the objects are located to determine segmentation results of the objects in the to-be-processed image.

2. The method of claim 1, wherein the segmentation regions of the objects in the to-be-processed image include a core segmentation region of a first object, and the first object is an object belonging to a first class in the objects; and
wherein performing the first segmentation processing on the to-be-processed image to determine the segmentation regions of the objects in the to-be-processed image comprises:
performing a core segmentation processing on the to-be-processed image through a core segmentation network to determine the core segmentation region of the first object.

3. The method of claim 2, wherein the segmentation results of the objects include a segmentation result of the first object; and
wherein performing the second segmentation processing on the image regions where the objects are located to determine the segmentation results of the objects in the to-be-processed image comprises:
performing, through a first instance segmentation network, an instance segmentation on the image region where the first object is located to determine the segmentation result of the first object.

4. The method of claim 3, wherein the segmentation regions of the objects in the to-be-processed image comprise a segmentation region of a second object, and the second object is an object belonging to a second class in the objects; and
wherein performing the first segmentation processing on the to-be-processed image to determine the segmentation regions of the objects in the to-be-processed image further comprises:
performing, through a second instance segmentation network, an instance segmentation on the to-be-processed image to determine the segmentation result of the second object.

5. The method of claim 4, further comprising:
determining a fused segmentation result of the objects in the to-be-processed image by fusing the segmentation result of the first object and the segmentation result of the second object.

6. The method of claim 2, wherein the to-be-processed image comprises a three-dimensional (3D) vertebral image, and the 3D vertebral image comprises multiple slice images in a cross-sectional direction of a vertebra; and
wherein performing the core segmentation processing on the to-be-processed image through the core segmentation network to determine the core segmentation region of the first object comprises:
performing the core segmentation processing on an object slice image group through the core segmentation network to obtain a core segmentation region of the first object on an object slice image, wherein the object slice image group comprises the object slice image and 2N slice images adjacent to the object slice image, the object slice image is any one of the multiple slice images, and N is a positive integer; and
determining the core segmentation region of the first object according to core segmentation regions of the multiple slice images.

7. The method of claim 6, wherein determining the core segmentation region of the first object according to the core segmentation regions of the multiple slice images comprises:
determining multiple 3D core segmentation regions respectively according to the core segmentation regions of the multiple slice images; and
optimizing the multiple 3D core segmentation regions to obtain the core segmentation region of the first object.

8. The method of claim 1, further comprising:
determining a central point position of each segmentation region according to the segmentation regions of the objects in the to-be-processed image.

9. The method of claim 1, further comprising:
determining initial central point positions of the segmentation regions of the objects according to the segmentation regions of the objects in the to-be-processed image; and
optimizing the initial central point positions of the segmentation regions of the objects to determine the central point position of each segmentation region.

10. The method of claim 1, wherein performing the first segmentation processing on the to-be-processed image to determine the segmentation regions of the objects in the to-be-processed image comprises:
performing resampling and pixel value reduction on the to-be-processed image to obtain a processed first image;
performing a central crop on the processed first image to obtain a cropped second image; and
performing the first segmentation processing on the cropped second image to determine the segmentation regions of the objects in the to-be-processed image.

11. The method of claim 1, wherein determining, according to the central point positions of the segmentation regions of the objects, the image regions where the objects are located comprises:
determining, for any object, the image region where the object is located according to a central point position of the object and at least one central point position adjacent to the central point position of the object.

12. The method of claim 4, further comprising:
training a neutral network according to a preset training set, wherein the neutral network includes at least one of the core segmentation network, the first instance segmentation network or the second instance segmentation network, and the preset training set includes multiple annotated sample images.

13. The method of claim 4, wherein the first class includes at least one of a cervical vertebra, a spine, a lumbar vertebra or a thoracic vertebra; and the second class includes a caudal vertebra.

14. An apparatus, comprising:
a memory storing processor-executable instructions; and
a processor configured to execute the processor-executable instructions to perform operations of:
performing a first segmentation processing on a to-be-processed image to determine segmentation regions of objects in the to-be-processed image;
determining, according to central point positions of the segmentation regions of the objects, image regions where the objects are located; and
performing a second segmentation processing on the image regions where the objects are located to determine segmentation results of the objects in the to-be-processed image.

15. The apparatus of claim 14, wherein the segmentation regions of the objects in the to-be-processed image include a core segmentation region of a first object, and the first object is an object belonging to a first class in the objects; and
wherein performing the first segmentation processing on the to-be-processed image to determine the segmentation regions of the objects in the to-be-processed image comprises:
performing a core segmentation processing on the to-be-processed image through a core segmentation network to determine the core segmentation region of the first object.

16. The apparatus of claim 15, wherein the segmentation results of the objects include a segmentation result of the first object; and
wherein performing the second segmentation processing on the image regions where the objects are located to determine the segmentation results of the objects in the to-be-processed image comprises:
performing, through a first instance segmentation network, an instance segmentation on the image region where the first object is located to determine the segmentation result of the first object.

17. The apparatus of claim 16, wherein the segmentation regions of the objects in the to-be-processed image comprise a segmentation region of a second object, and the second object is an object belonging to a second class in the objects; and
wherein performing the first segmentation processing on the to-be-processed image to determine the segmentation regions of the objects in the to-be-processed image further comprises:
performing, through a second instance segmentation network, an instance segmentation on the to-be-processed image to determine the segmentation result of the second object.

18. The apparatus of claim 17, wherein the processor is configured to execute the processor-executable instructions to further perform an operation of:
determining a fused segmentation result of the objects in the to-be-processed image by fusing the segmentation result of the first object and the segmentation result of the second object.

19. The apparatus of claim 15, wherein the to-be-processed image comprises a three-dimensional (3D) vertebral image, and the 3D vertebral image comprises multiple slice images in a cross-sectional direction of a vertebra; and
wherein performing the core segmentation processing on the to-be-processed image through the core segmentation network to determine the core segmentation region of the first object comprises:
performing the core segmentation processing on an object slice image group through the core segmentation network to obtain a core segmentation region of the first object on an object slice image, wherein the object slice image group comprises the object slice image and 2N slice images adjacent to the object slice image, the object slice image is any one of the multiple slice images, and N is a positive integer; and
determining the core segmentation region of the first object according to core segmentation regions of the multiple slice images.

20. A non-transitory computer-readable storage medium having stored thereon computer-readable instructions that, when executed by a processor, cause the processor to perform a method, comprising:
performing a first segmentation processing on a to-be-processed image to determine segmentation regions of objects in the to-be-processed image;
determining, according to central point positions of the segmentation regions of the objects, image regions where the objects are located; and
performing a second segmentation processing on the image regions where the objects are located to determine segmentation results of the objects in the to-be-processed image.
